(19) United States
(12) Patent Application Publication
(10) Pub. No.: US 2025/0315122 A1
(43) Pub. Date: Oct. 9, 2025

(54) INTERACTIVE MIRROR

(71) Applicant: Syn Technologies, Riverdale, GA (US)

(72) Inventors: Katherine Gilligan, Atlanta, GA (US); Darius Smith, Atlanta, GA (US)

(21) Appl. No.: 19/171,074

(22) Filed: Apr. 4, 2025

Related U.S. Application Data
(60) Provisional application No. 63/574,680, filed on Apr. 4, 2024.

(51) Int. Cl. G06F 3/041; F21V 33/00; G06F 3/01; G06F 3/044

(52) U.S. Cl. CPC G06F 3/0416; F21V 33/004; G06F 3/012; G06F 3/044; G06F 2203/011

(57) ABSTRACT

An interactive mirror including a housing, a two-way mirror disposed within the housing, an interactive display positioned behind the two-way mirror such that an output of the display is visible through the two-way mirror, a camera supported on the housing, a lighting element disposed on the housing, the lighting element configured to emit light, and an electronic processor. The electronic processor is configured to receive a camera signal, determine an environmental lighting profile based on the camera signal, generate a light output level corresponding to the determined environmental lighting profile, and controlling the lighting system to emit light at the light output level.

### CROSS-REFERENCE TO RELATED APPLICATIONS

This application claims priority to U.S. Provisional Application No. 63/574,680, filed Apr. 4, 2024, the entire contents of which are incorporated by reference herein.

### FIELD

The embodiments disclosed herein relate to a two-way mirror including an interactive electronic device and an adaptive lighting system.

### BACKGROUND

Two-way mirrors are semi-transparent mirror surfaces that reflect a portion of the light emitted at the mirror and let the rest pass through the mirror. This property is often used in surveillance settings as, a first side of the mirror may view a second side of the mirror, and if the lighting on the second side is sufficiently larger than the first side, the second side may only view their own reflection. Conversely, if the lighting difference between the first and second side is less extreme, the first side may see both their own reflection and the light passing through the second side when viewing a two-way mirror.

In some settings (e.g., makeup tutorials), it may be desirable to view both a reflection and a display. Additionally, having control over the surrounding lighting allows for both control over the reflected image as viewed through the mirror and to better simulate an outdoor environment.

### SUMMARY

In some aspects, the concepts described herein relate to an interactive mirror including a housing, a two-way mirror disposed within the housing, an interactive display positioned behind the two-way mirror such that an output of the display is visible through the two-way mirror, a camera supported on the housing, a lighting element disposed on the housing, the lighting element configured to emit light, and an electronic processor. The electronic processor is configured to receive a camera signal, determine an environmental lighting profile based on the camera signal, generate a light output level corresponding to the determined environmental lighting profile, and controlling the lighting system to emit light at the light output level.

In some aspects, the concepts described herein relate to a method for operating an interactive mirror, the method including receiving a camera signal from one or more cameras, determining an environmental lighting profile based on the camera signal, generating a light output level corresponding to the determined environmental lighting profile, and controlling a lighting element to emit light at the light output level.

In some aspects, the concepts described herein relate to an interactive mirror including a housing, a two-way mirror disposed within the housing, the two-way mirror including a partially transparent material, an interactive display positioned behind the two-way mirror such that an output of the display is visible through the two-way mirror, and a camera supported on the housing; and a lighting element disposed on the housing, the lighting element configured to emit light along the entirety of the visual spectrum.

Other aspects of the technology will become apparent by consideration of the detailed description and accompanying drawings.

### BRIEF DESCRIPTION OF THE DRAWINGS

FIG. 1 is an interactive mirror, according to some embodiments.

FIG. 2 is an exemplary user interaction with the interactive mirror of FIG. 1, according to some embodiments.

FIG. 3 an embodiment of a rear portion of the interactive mirror of FIG. 1, according to some embodiments.

FIG. 4 is an exploded view of the interactive mirror of FIG. 1, according to some embodiments.

FIG. 5 is a block diagram illustrating a control system for the interactive mirror of FIG. 1, according to some embodiments.

FIG. 6 illustrates a communication network for the interactive mirror of FIG. 1, according to some embodiments.

FIG. 7 illustrates the Kelvin temperature scale.

FIG. 8 is a flow chart illustrating a process for adjusting the lighting level output of the lighting system for the interactive mirror of FIG. 1, according to some embodiments.

FIG. 9 is a flow chart illustrating a process for detecting the mood of a user for the interactive mirror of FIG. 1.

FIG. 10 illustrates an exemplary user interface of the interactive mirror of FIG. 1.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. As used within this document, the word “or” may mean inclusive or. As a non-limiting example, if examples in this document state that “item Z may comprise element A or B,” this may be interpreted to disclose an item Z comprising only element A, an item Z comprising only element B, as well as an item Z comprising elements A and B.

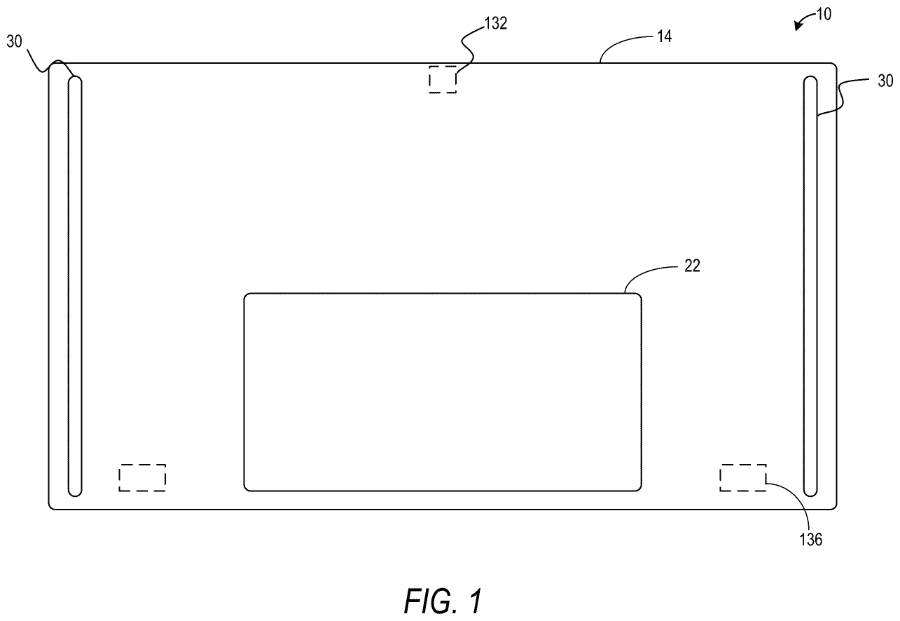

FIGS. 1-4 illustrate an interactive mirror 10. The interactive mirror 10 may be configured to perform multiple operations, such as adapt a lighting level based on a user input, sensor values, a determined mood of the user, and/or other parameters or inputs as required for a given application. The interactive mirror 10 may further be configured to create a user profile, use Artificial Intelligence to suggest a cosmetic product, haircut, or lighting arrangement, and/or perform other various processes and/or actions based on a user using interactive mirror 10.

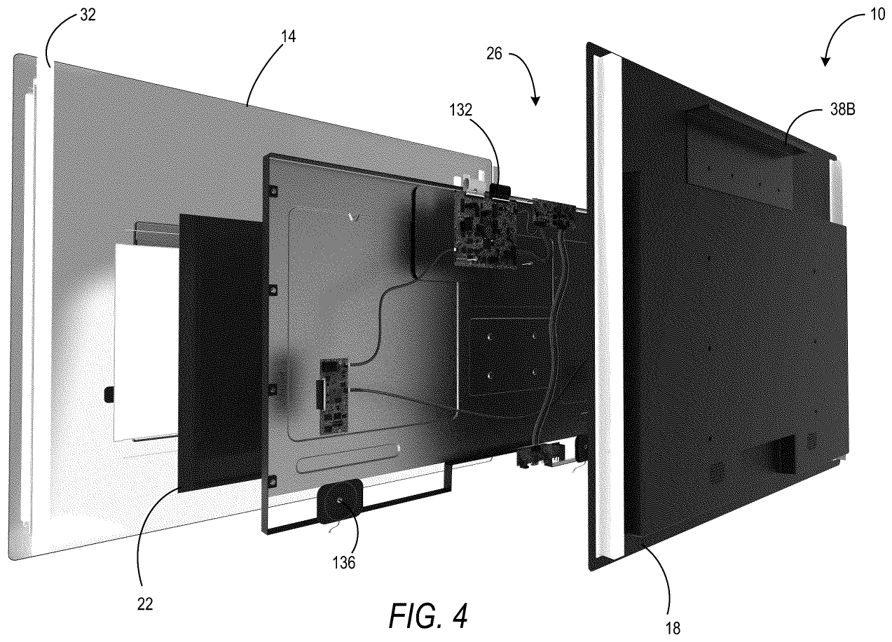

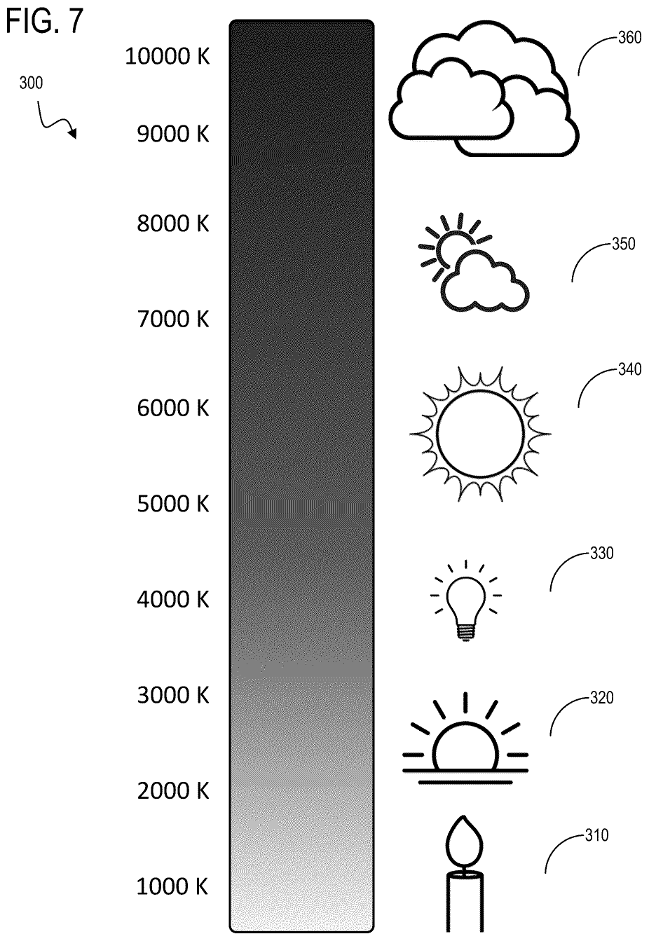

The interactive mirror 10 includes a two-way mirror 14, a mirror housing 18, a display device 22, and an electronics housing 26. With specific reference to FIGS. 1 and 4, the interactive mirror 10 also includes at least one light strip 30, which will be described in further detail when discussing FIG. 7. In the illustrated embodiment, the display device 22 and electronics housing 26 are supported between the mirror housing 18 and the two-way mirror 14, with the display device 22 being placed directly behind the two-way mirror 14. As particularly shown in FIG. 4, the at least one light strip 30 extends from the mirror housing 18, around the display device 22 and through slots 32 in the two-way mirror 14. Accordingly, the light emitted from the light strip 30 will not interfere with the light emit from the display device 22. In some embodiments, the mirror housing 18 may fully encase the display device 22 such that display light will only be seen through the two-way mirror 14.

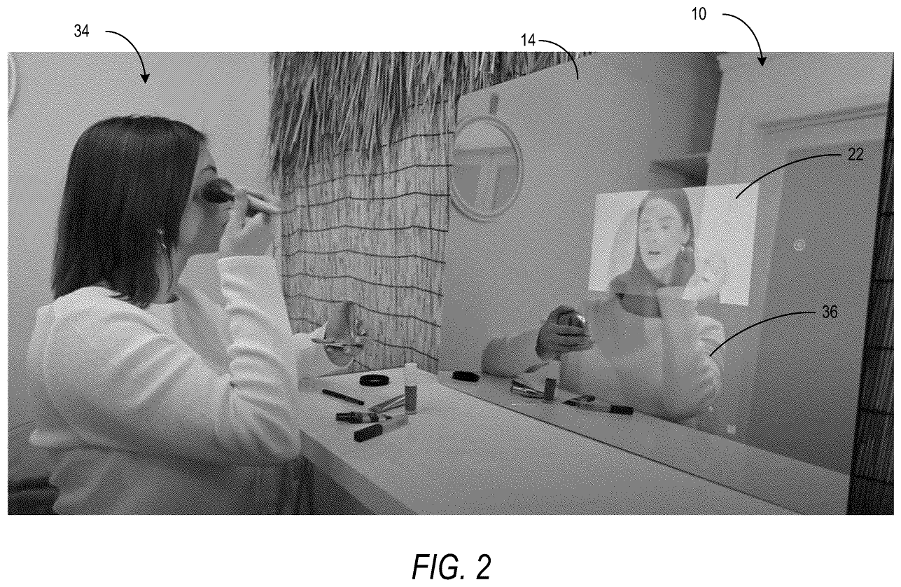

With specific reference to FIG. 2, the two-way mirror 14 is a partially transparent mirror surface configured to partially reflect the light from outside the interactive mirror 10 and allow a portion of the display light from the display device 22 to pass through. Thus, a user 34 may view both a reflection 36 and the display light output from the display device 22. In some embodiments, the two-way mirror 14 may be partially transparent along the entirety of the mirror surface. In the illustrated embodiment, the display device 22 is a touch screen. In some embodiments, the two-way mirror 14 may be a sufficient thickness and/or material (e.g., acrylic) to allow for the display device 22 to detect a user interaction with the two-way mirror. For example, in an embodiment where the display device 22 is a capacitive touch screen, the two-way mirror 14 will be conductive enough to allow for the flow of charge from the user 34 to the touch screen.

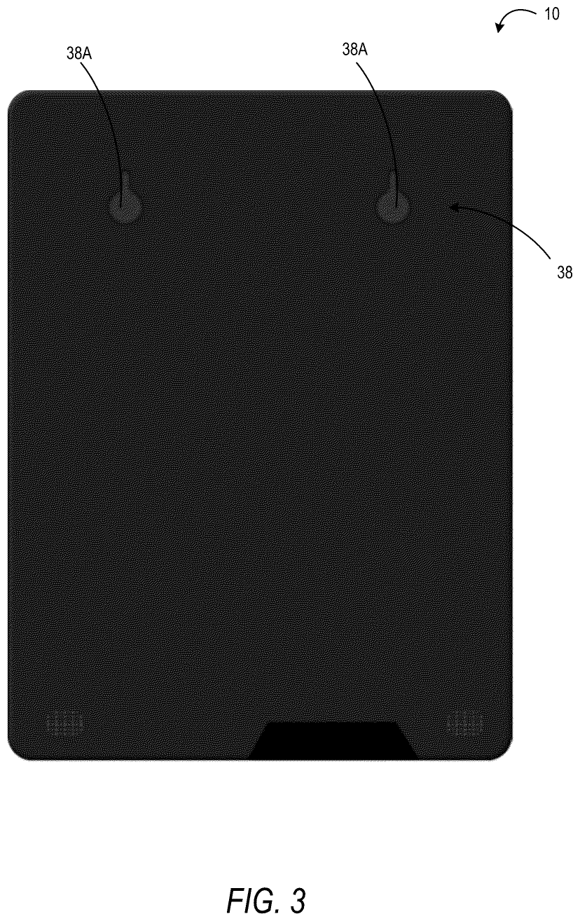

As illustrated in FIGS. 3 and 4, the mirror housing 18 further includes a mounting interface 38. In the embodiment of FIG. 3, the mounting interface 38 includes two mounting holes 38A. The mounting holes 38A are configured to receive a corresponding mounting stud coupled to a wall, thereby allowing the interactive mirror 10 to be hung from a walled surface. In some embodiments the mounting interface 38 may also include additional support elements (e.g., rubber stops) to allow the interactive mirror 10 to be supported on a flat surface or leaned against a walled surface without falling. In some embodiments the interactive mirror 10 may be box-shaped and accordingly have a large enough surface area to be supported on a flat surface without the inclusion of additional support elements. In the embodiment of FIG. 4, the mirror housing 18 further includes a mounting bracket 38B extending from a portion of the mirror housing 18. The mounting bracket 38B is configured to couple to a corresponding wall mount.

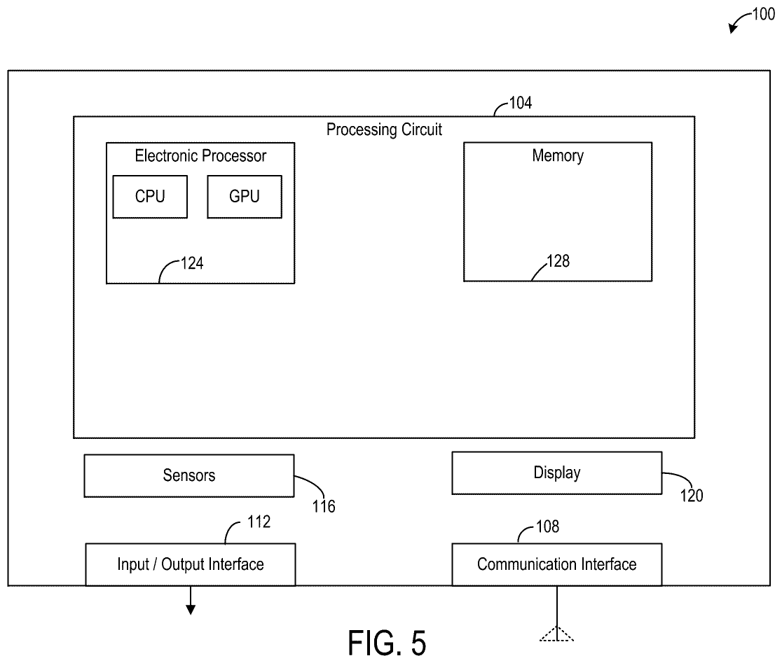

Turning now to FIG. 5, a block diagram of the control system 100 for the interactive mirror 10 is shown, according to some embodiments. As shown in FIG. 5, the control system 100 includes a processing circuit 104, a communication interface 108, an input/output (I/O) interface 112, a plurality of sensors 116 (described in further detail below) and a display 120. While the control system 100 is shown with respect to a processing circuit 104 and a display 110, it is contemplated that multiple other devices may be used in the system 100, such as additional sensors (motion sensors, microphones, humidity sensors, touch sensors etc.) and/or any other device that may be utilized within an interactive display system. Accordingly, the processor circuit 104 and sensors described herein are for exemplary purpose and are understood not to be limiting.

The processing circuit 104 includes an electronic processor 124 and a memory 128. The processing circuit 104 may be communicably connected to one or more of the communication interface 108 and the I/O interface 112. The electronic processor 124 may be implemented as a programmable microprocessor, an application specific integrated circuit (ASIC), one or more field programmable gate arrays (FPGA), a group of processing components, or with other suitable electronic processing components. In some embodiments the electronic processor 124 may also include an additional graphical processing unit (GPU).

The memory 128 (for example, a non-transitory, computer-readable medium) includes one or more devices (for example, RAM, ROM, flash memory, hard disk storage, etc.) for storing data and/or computer code for completing or facilitating the various processes, layers, and modules described herein. The memory 128 may include database components, object code components, script components, or other types of code and information for supporting the various activities and information structure described in the present application. According to one example, the memory 128 is communicably connected to the electronic processor 124 via the processing circuit 104 and may include computer code for executing (for example, by the processing circuit 104 and/or the electronic processor 124) one or more processes described herein.

The I/O interface 112 may be configured to interface directly with one or more devices, such as a power supply, one or more light strips 30, one or more sensors 116 (e.g., a camera 132, a plurality of speakers 136, other light sensors, a microphone), other communication equipment, etc. In one embodiment, the I/O interface 206 may utilize general purpose I/O (GPIO) ports, analog inputs, digital inputs, etc.

The communication interface 108 may be, or include, wireless communication interfaces (for example, antennas, transmitters, receivers, transceivers, etc.) for conducting data communications between the control system 100 and one or more external devices, such as those described above. In other embodiments, other wireless communication protocols may also be used, such as Bluetooth®, cellular (3G, 4G, 5G, LTE, CDMA, etc.), Wi-Fi, LoRa, LoRaWAN, Z-wave, Thread, and/or any other applicable wireless communication protocol. The communication interface 108 may be configured to communicate with one or more external devices, such as a smartphone, dedicated user device, smart watch, computer, tablet computer, and/or other connected devices as required for a given application.

The I/O interface 106 is configured to facilitate communication between the control system 100 and one or more external devices or systems, such as lighting elements (e.g., light strip 30), a camera 132, a plurality of speakers 136 and/or other devices as required for a given application.

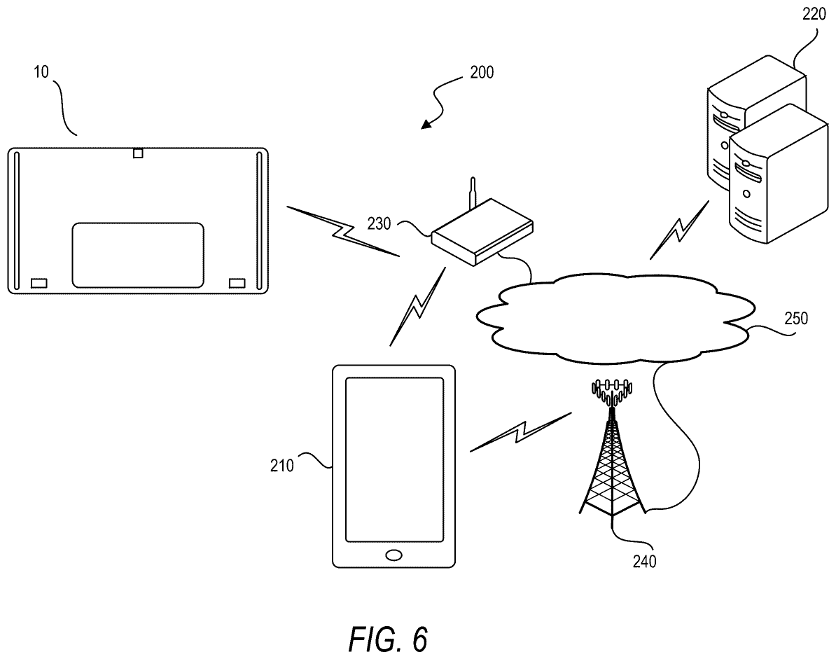

As exemplified in FIG. 6, the communication interface 108 may facilitate a communication network 200 using one or more communication protocols. The communication network includes the interactive mirror 10 and an external device 210. The interactive mirror 10 may communicate status, operation statistics, identification, sensor data, usage information, maintenance data, and the like.

Using the external device 210, a user 34 can access data stored within the memory 128 of the interactive mirror 10. For example, the user 34 may receive information about a recommended cosmetic, haircut, and/or outfit as previously determined by the interactive mirror 10. The external device 210 may also transmit data to the interactive mirror 10 through the communication network 200 for firmware updates, to send commands, include potential products and profiles, etc.

The external device 210 is for example, a smart phone (as illustrated), a laptop computer, a tablet computer, a personal digital assistant (PDA), or another electronic device capable of communication wirelessly with the interactive mirror 10. The external device 210 provides a user interface and allows a user to access and interact with the interactive mirror 10, enable or disable features, and the like. The user interface of the external device 210 may provide an easy-to-use interface for the user to control and customize operation of the interactive mirror 10.

In addition, with continued reference to FIG. 6, the communication network 200 may further include a remote server 220 may be connected to the interactive mirror 10. The remote server 220 may be used to store the operational data obtained from the interactive mirror 10, provide additional processing functionality and service to the user, or a combination thereof. In some embodiments, storing the information on the remote server 220 allows a user to access the information from a plurality of different locations. The remote server 220 may also be used to send programmable operations and firmware updates to the interactive mirror 10. The network 200 may include various networking elements (routers 230, hubs, switches, cellular towers 240, wired connections, wireless connections, etc.) for connecting to, for example, the Internet 250, a cellular data network, a local network, or a combination thereof.

FIG. 7 illustrates the Kelvin temperature scale and correlates a color temperature with a plurality of exemplary light sources. Specifically, FIG. 7 shows a correlation between a candlelight light level 310 having a color temperature of 1000-2000K, a sunrise/sunset light level 320 having a color temperature of 3000K-4000K, a fluorescent lamp light level 330 having a color temperature of 4000-5000K, a daylight light level 340 having a color temperature of 5000-6500K, an overcast light level 350 having a color temperature of 6500-8000K, and a heavy overcast sky light level 360 having a color temperature of 9000-10000K.

With continued reference to FIG. 7, the at least one light strip 30 is configured controllably output light within a plurality of color temperatures and intensities (or luminosities). More specifically, the light strip 30 is configured to be a full-spectrum light, or said another way emit light that includes the electromagnetic spectrum from infrared to near-ultraviolet light to mimic natural light. To achieve a full-spectrum light, one exemplary method is to coat a light-emitting diode (LED) or a casing for an LED in a coating that refracts light along the entirety of the visible spectrum. In some embodiments, each light strip 30 may include a single grouping of LED's operable within the entirety of the Kelvin temperature scale. In some embodiments, the light strip 30 may include a plurality of LED strips operable within different specified ranges of the Kelvin temperature scale. For example, the light strip 30 may include a plurality of LED's operable between 1000-4000K, 5000-7000K, and 8000-10000K respectively. In such an embodiment, the light strip 30 may alternate between different LED strips in order to operate within a specific color temperature or may dim the LED's operable outside the desired color temperature. In some embodiments, each LED within the light strip 30 may be individually addressable and controlled through the processing circuit 104. In some embodiments, the covering and/or frosting of the light strips may further increase the color range for the light strip 30. In other embodiments, the light strip 30 may also include LED's that are not modified to emit at a full spectrum, thereby allowing additional lighting environments.

The light strip 30 may also be operably controlled by the processing circuit 104 based on a reading from one or more sensors 116 and via a user input. For example, the interactive mirror 10 may determine a distance of a user 34 to the two-way mirror 14 using a sensor (e.g., a distance sensor, the camera 132, etc.) and adjust the intensity or color of the light strip 30. In another example, the processing circuit 104 may determine a time, date, and/or environmental condition using the camera 132, through a database, and/or by user input and adjust the light output (e.g., color, color temperature, intensity, etc.) by the light strip 30 to match the ambient environment. In yet another example, the processing circuit 104 may compare a lighting intensity value of light sensors on opposite sides of the two-way mirror 14 and adjust the intensity of the display device 22 and/or the light strip 30.

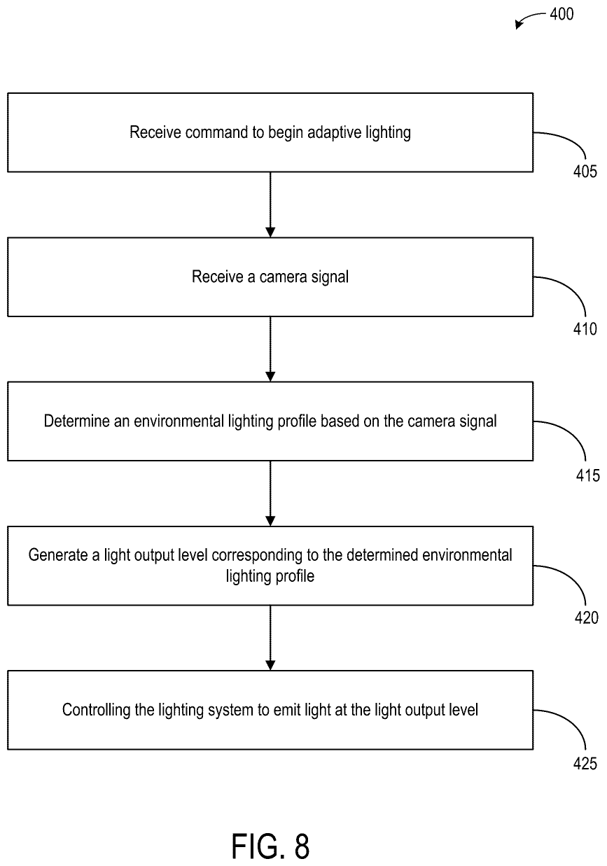

FIG. 8 illustrates a process 400 for determining an output lighting level of an interactive mirror, such as interactive mirror 10. In some embodiments, the output lighting level may correspond with a specific ambient condition (e.g., a daylight level 340) or a preset light setting (e.g., a user input RGB ratio) at a determined intensity. At process block 405 the processing circuit 104 receives a command to begin adaptive lighting. In some embodiments, the command may begin upon detection of a user based on a sensor or a user interaction. In other embodiments, the process 400 may be initiated at process block 405 through an explicit command from the user 34. At process block 410 the processing circuit 104 receives image data from the camera 132. In some embodiments, the image data may be a combination of picture and video signals received through the I/O interface 112. In some embodiments, the image data may additionally include sensor signals from light sensors (not shown) disposed inside and outside the mirror housing 18, environmental data stored within the memory 128, and/or other metadata associated with a captured image.

At process block 415 the processing circuit 104 determines an environmental characteristic based on the received image data. For example, the processing circuit 104 may reference an averaged brightness value from the image data and compare the image data to predetermined baseline in order to determine an estimated brightness, color, and color temperature to create an environmental lighting profile. In some embodiments, the processing circuit 104 may store a plurality of reference values within the memory 128 including a facial mapping characteristic of the user, lighting reference values to determine brightness, color reference values to determine current color and color temperature, and other calibration values related to creating a baseline for the environment and user. In such an embodiment, the environmental reference values may be compared with the camera signal in order to determine the environmental lighting profile. In some embodiments, the processing circuit 104 may also reference the Internet to pull location and weather data to adjust the environmental characteristic. For example, the processing circuit 104 may use the communication interface 108 to communicate with a database to determine that the sun is setting at the interactive mirror's location, and thereby adjust the output light color temperature to a sunset light level 320.

At process block 420 the processing circuit 104 determines a light output level corresponding to the determined environmental lighting profile. For example, the processing circuit 104 may determine an output color and color temperature based on the color and color temperature measured. The processing circuit 104 may also take into account other sensor readings such as light sensors inside and outside the two-way mirror 14 and adjust the determined light output level to allow for a user to view both a reflection and the display device 22. In some embodiments, the circuit 104 may additionally determine and correspondingly generate a light output level to adjust the display output.

At process block 425, the processing circuit 104 controls the light strip 30 through the I/O interface 112 to output light at the appropriate color, color temperature, and intensity according to the determined light output level. As previously discussed, in some embodiments the output of the display device 22 may also be adjusted.

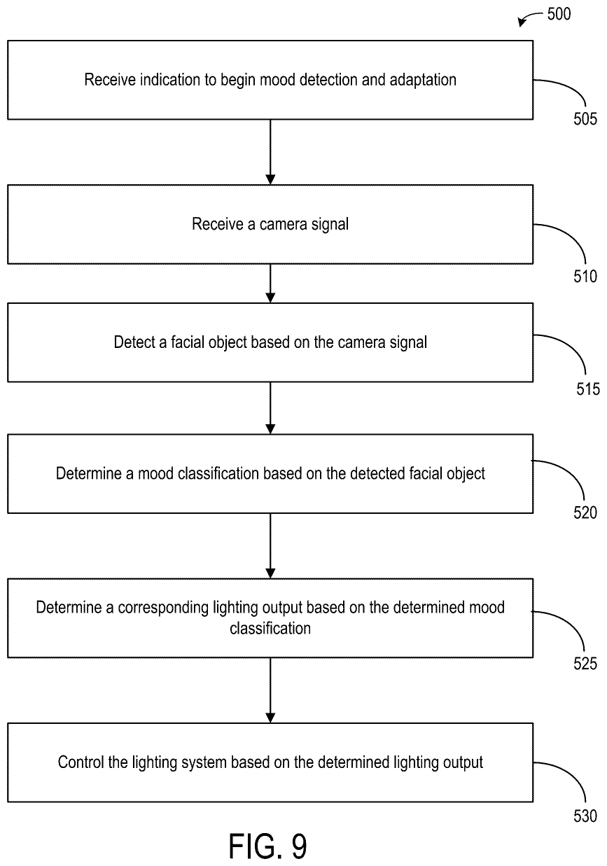

FIG. 9 illustrates a process 500 for adapting a lighting level based on a mood of the user. Process 500 is similar to process 400 and operations utilized in process 400 may also be utilized in process 500. At process block 505 the processing circuit 104 receives a command to begin mood detection and adaptation. In some embodiments, the command may begin upon detection of a user based on a sensor or a user interaction. In other embodiments, the process 500 may be initiated at process block 505 through an explicit command from the user 34. At process block 510 the processing circuit 104 receives image data from the camera 132. In some embodiments, the image may be a combination of picture and video signals received through the I/O interface 112. In some embodiments, the image data may additionally include sensor signals from light sensors (not shown) disposed inside and outside the mirror housing 18, other environmental data stored within the memory 128, and/or metadata associated with the image data.

At process block 515, the processing circuit 104 detects a facial object based on the received image data. In some embodiments, the processing circuit 104 may utilize a facial recognition algorithm to identify a face. In such an embodiment, the facial recognition algorithm may utilize a neural network. At process block 520, the processing circuit 104 may determine a mood classification based on identified face. In some embodiments, the identified face may be cropped and preprocessed to determine a plurality of identifying features (e.g., distance between eyes, relative position of nose and ears, etc.). The processing circuit 104 may then utilize image recognition neural network trained on mood data to determine a mood classification based on the detected facial object.

At process block 525 the processing circuit 104 may determine a corresponding lighting output based on the determined mood classification. For example, the processing circuit may compare the mood classification determined at process block 520 with a look-up table stored within the memory 128 to determine a corresponding color, color temperature, and intensity that matches with the detected mood.

At process block 530 the processing circuit 104 controls the light strip 30 through the I/O interface 112 to output light at the appropriate color, color temperature, and intensity according to the determined light output level. As previously discussed, in some embodiments the output of the display device 22 may also be adjusted.

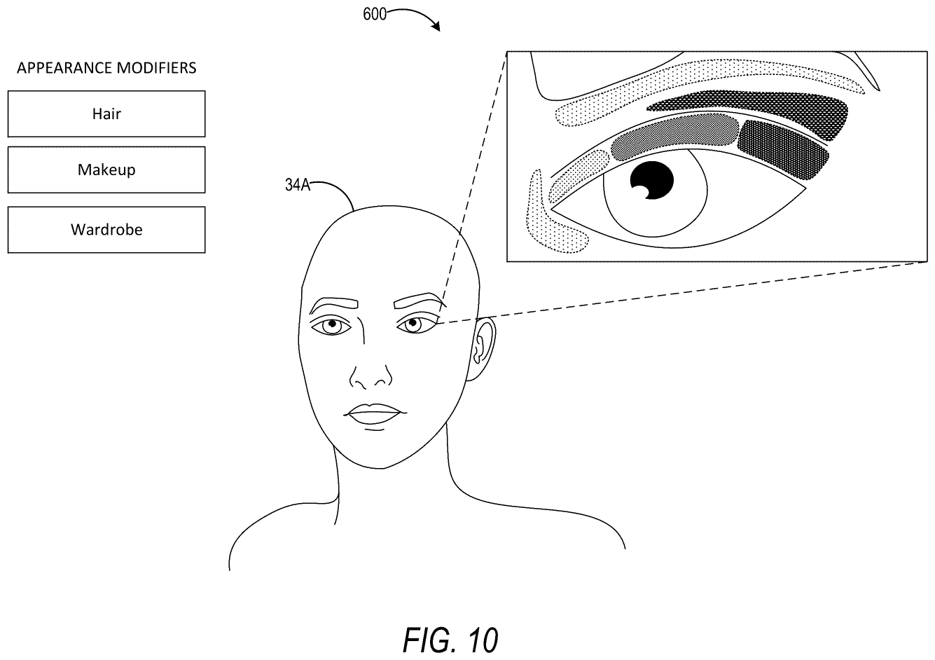

FIG. 10 illustrates an exemplary user interface 600. The processing circuit 104 may be further configured to develop a user profile 34A based on image data of the user 34. Using the image data of the user 34, the processing circuit may utilize an image recognition algorithm and image generation algorithm to generate recommendations for different hair styles, makeup, wardrobe, and ideal lighting arrangement.

Various features and advantages of the invention are set forth in the following claims.

What is claimed is:

1. An interactive mirror comprising:
a housing;
a two-way mirror disposed within the housing;
an interactive display positioned behind the two-way mirror such that an output of the display is visible through the two-way mirror;
a camera supported on the housing;
a lighting element disposed on the housing, the lighting element configured to emit light; and
an electronic processor operably connected with the display, the camera, and the lighting element, the electronic processor configured to:
receive a camera signal;
determine an environmental lighting profile based on the camera signal;
generate a light output level corresponding to the determined environmental lighting profile; and
control the lighting element to emit light at the light output level.

2. The interactive mirror of claim 1, wherein an entirety of a surface of the two-way mirror is partially transparent.

3. The interactive mirror of claim 1, wherein the interactive display is a touch screen operable through the two-way mirror.

4. The interactive mirror of claim 3, wherein the interactive display is a capacitive touch screen and wherein the two-way mirror is configured such that charge may flow from a user through the two-way mirror and into the capacitive touch screen.

5. The interactive mirror of claim 4, wherein the two-way mirror further comprises an acrylic material.

6. The interactive mirror of claim 1, further comprising:
a first light sensor disposed within the housing behind the two-way mirror adjacent to the interactive display, the first light sensor configured to output a first light signal corresponding to the light output by the interactive display, and
a second light sensor disposed outside the housing adjacent to the two-way mirror, the second light sensor configured to output a second light signal corresponding to an environment brightness.

7. The interactive mirror of claim 6, wherein the electronic processor is further configured to:
calculate a light intensity value based on the signals received from the first light sensor and the second light sensor, and
control at least one of the interactive display and the lighting element based on the calculated light intensity value.

8. The interactive mirror of claim 1, wherein the lighting element is a light strip comprising a plurality of LEDs, wherein the lights strip is configured to output light within an entirety of Kelvin temperature scale.

9. The interactive mirror of claim 1, wherein the determination of an environmental lighting profile further includes comparing the camera signal to a predetermined baseline to determine an estimated brightness, color, and color temperature.

10. The interactive mirror of claim 1, wherein the housing includes a mounting interface defining a plurality of mounting holes configured to couple to a wall.

11. The interactive mirror of claim 1, further comprising:
a motion sensor,
a microphone,
a humidity sensor,
one or more light sensors, and
a wireless communication interface,
wherein each of the motion sensor, the microphone, the humidity sensor, the one or more light sensors, and the wireless communication interface are operatively coupled to the electronic processor.

12. A method for operating an interactive mirror, the method comprising:
receiving a camera signal from one or more cameras;
determining an environmental lighting profile based on the camera signal;
generating a light output level corresponding to the determined environmental lighting profile; and
controlling a lighting element to emit light at the light output level.

13. The method of claim 12, wherein determining an environmental lighting profile further includes comparing the camera signal to a predetermined baseline to determine an estimated brightness, color, and color temperature.

14. The method of claim 12, wherein determining an environmental lighting profile further includes adjusting the environmental lighting profile based on at least one of a time, a location, and a weather signal received through a wireless connection.

15. The method of claim 12, wherein determining an environmental lighting profile further includes receiving a signal through a user interface.

16. An interactive mirror comprising:
a housing;
a two-way mirror disposed within the housing, the two-way mirror including a partially transparent material;
an interactive display positioned behind the two-way mirror such that an output of the display is visible through the two-way mirror;
a camera supported on the housing; and
a light strip comprising a plurality of LEDs.

17. The interactive mirror of claim 16, wherein the lights strip is configured to output light within an entirety of Kelvin temperature scale.

18. The interactive mirror of claim 17, wherein the light strip is a full-spectrum light configured to emit light ranging from infrared to near-ultraviolet light.

19. The interactive mirror of claim 16, wherein the interactive display is a touch screen operable through the two-way mirror.

20. The interactive mirror of claim 19, wherein the interactive display is a capacitive touch screen and wherein the two-way mirror is configured such that charge may flow from a user through the two-way mirror and into the capacitive touch screen.
